(19) United States
(12) Patent Application Publication
(10) Pub. No.: US 2019/0114575 A1
(43) Pub. Date: Apr. 18, 2019

(54) MULTICOMPUTER PROCESSING OF USER DATA WITH CENTRALIZED EVENT CONTROL

(71) Applicant: Bank of America Corporation, Charlotte, NC (US)

(72) Inventors: Mohamed A. Gahnoog, Charlotte, NC (US); Cameron Darnell Wadley, Waxhaw, NC (US); Minh N. Vuong, Clovis, CA (US); Susan Varghese, Atlanta, GA (US); Katherine Dintenfass, Lincoln, RI (US); William August Stahlhut, Charlotte, NC (US)

(21) Appl. No.: 15/783,767

(22) Filed: Oct. 13, 2017

(51) Int. Cl. G06Q 10/06; G06N 99/00

(52) U.S. Cl. CPC G06Q 10/063114; H04L 51/16; G06N 99/005

(57) ABSTRACT

Aspects of the disclosure relate to systems and methods for supervision of objectives and verification of completion of tasks associated with objectives. A computing platform may determine an objective and a series of tasks associated with that objective. Completion of the series of tasks may contribute to that objective by effecting a change to user data. The system may verify that a task has been completed by receiving task completion progress information, and effect a change to user data to reflect the task completion. The tasks associated with objectives may be determined or altered by a machine learning engine of the first computing platform.

### BACKGROUND

Aspects of the disclosure relate to electrical computers, digital processing systems, and multicomputer data processing. In particular, one or more aspects of the disclosure relate to enabling multicomputer processing of data from social media service computing platforms with centralized event control.

### SUMMARY

Aspects of the disclosure provide effective, efficient, scalable, and convenient technical solutions that address and overcome the technical problems associated with optimizing, maintaining, and utilizing computer systems and services. In particular, one or more aspects of the disclosure relate to techniques for enabling interactive and customizable controls for a supervisory user computing device with respect to interactions between a subordinate user computing device and a computing platform.

In accordance with one or more embodiments, a computing platform having at least one processor, a memory, and a communication interface may establish, via the communication interface, a first connection to a first supervisory user computing device. Then, while the first connection is established, the computing platform may receive, via the communication interface, from the first supervisory user computing device, information indicating an objective associated with a subordinate user. Next, while the first connection is established, the computing platform may receive, via the communication interface, from the first supervisory user computing device, information defining a plurality of tasks associated with the objective, where each task is associated with an event to cause a change to user data associated with the subordinate user. The computing platform may then receive, via the communication interface, task completion progress information, and identify, based on the task completion progress information, a first task of the plurality of tasks indicated by the task completion progress information. Subsequently, the computing platform may determine, based on a comparison of the information defining the first task with the task completion progress information, that the task completion progress information indicates completion of the first task. In response to determining that the task completion progress information indicates completion of the first task, the computing platform may generate a command directing an event validation computing platform to execute an event associated with the task. Finally, the computing platform may transmit, via the communication interface, to the event validation computing platform, the command directing the event validation computing platform to execute the event, where transmitting the command directing the event validation computing platform to execute the event causes the event validation computing platform to execute one or more actions to cause a change to user data associated with the subordinate user.

In some examples, the computing platform may establish, via the communication interface, a second connection to a subordinate user computing device associated with the subordinate user. In some aspects, the subordinate user computing device associated with the subordinate user may include one or more sensors. The task completion progress information may be received from the subordinate user computing device, and the task completion progress information may include information derived from at least one of the one or more sensors of the subordinate user computing device associated with the subordinate user. In yet other aspects, determining that the task completion progress information indicates completion of the first task may include comparing the information derived from at least one of the one or more sensors of the subordinate user computing device associated with the subordinate user of the task completion progress information with a corresponding piece of information defining the first task.

In some examples, the subordinate user computing device may be a wearable computing device, and may include a location sensor. In some aspects, the task completion progress information may include location information derived from the location sensor of the wearable computing device, and the information defining the first task may include location information. In some examples, the computing platform may establish, via the communication interface, a second connection to a subordinate user data source associated with the subordinate user, and the task completion progress information may be received, while the second connection is established, from the subordinate user data source.

In some examples, the computing platform may establish, via the communication interface, a second plurality of connections to a plurality of social media service computing platforms, and the task completion progress information may be received, while the second plurality of connections is established, from at least one of the plurality of social media service computing platforms. In some aspects, the task completion progress information may include social media activity feed data, and determining that the task completion progress information indicates completion of the first task may include comparing social media activity feed data with a corresponding piece of information defining the first task.

In some examples, the computing platform may establish, via the communication interface, a second connection to a second supervisory user computing device, and receive task completion progress information from the second supervisory user computing device. In some aspects, the task completion progress information may include a command from the second supervisory user computing device directing the computing platform that the first task is complete.

In some examples, the computing platform may transmit, via the communication interface, to the subordinate user computing device, a notification of the completion of the task, where transmitting the notification to subordinate user computing device causes the subordinate user computing device to display the notification of the completion of the task. In some examples, the computing platform may transmit, via the communication interface, to the first supervisory user computing device, a notification of the completion of the task, where transmitting the notification to the first supervisory user computing device causes the first supervisory user computing device to display the notification of the completion of the task.

In some examples, the computing platform may, in response to receiving information indicating an objective associated with a subordinate user, determine a task template corresponding to the objective, and transmit information indicating the task template to the first supervisory user computing device. In some examples, the computing platform may reprogram functionality of the computing platform, using a machine learning engine, to alter the task template prior to transmitting information indicating the task template to the first supervisory user computing device.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for validating and controlling events executed across multiple computing platforms and devices in accordance with one or more example embodiments;

FIGS. 2A-2E depict an illustrative event sequence for multicomputer processing of user data with centralized event control in accordance with one or more example embodiments;

FIG. 3 depicts an example graphical user interface to obtain supervisory confirmation of the completion of a task in accordance with one or more example embodiments;

FIG. 4 depicts an example notification to a subordinate user in accordance with one or more example embodiments; and

FIG. 5 depicts an illustrative method for multicomputer processing of user data with centralized event control in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Aspects of the disclosure relate to systems and methods for an operator of a supervisory user computing device to define an objective and a series of tasks associated with that objective for an operator of a subordinate user computing device to achieve. For example, an objective may be a financial objective, and completion of the series of tasks may contribute to that objective by executing a financial transaction related to that financial objective. The system may receive information related to the completion of tasks from various sources. Then, the system may verify that one of the plurality of tasks has been completed by analyzing the received information related to the completion of tasks, and effect a change to user data associated with the operator of the subordinate user computing device in response to the completion of the task.

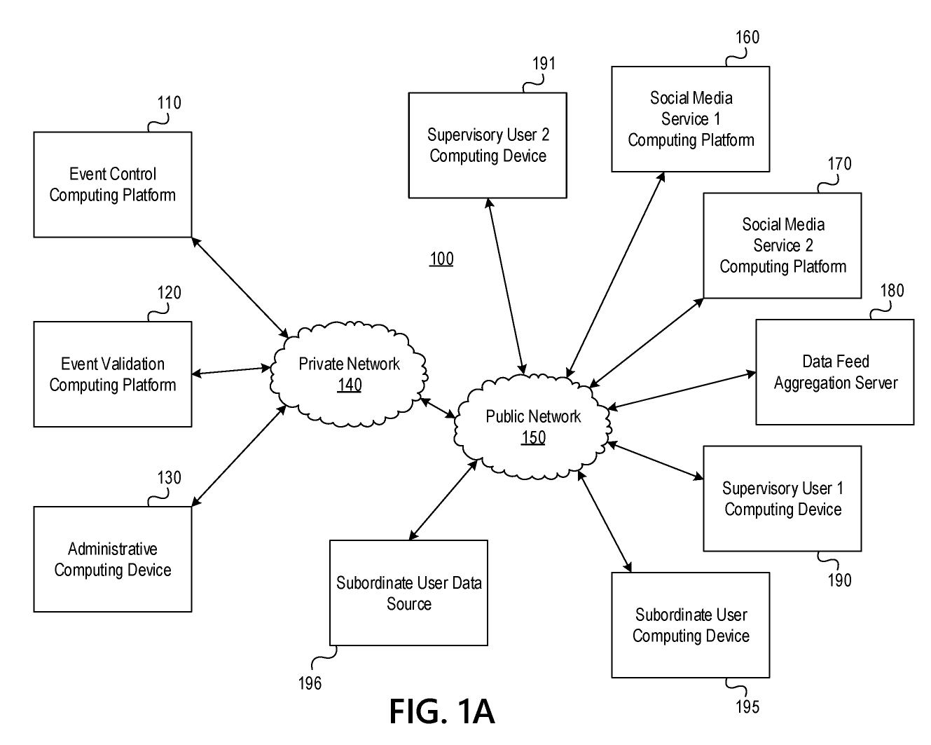

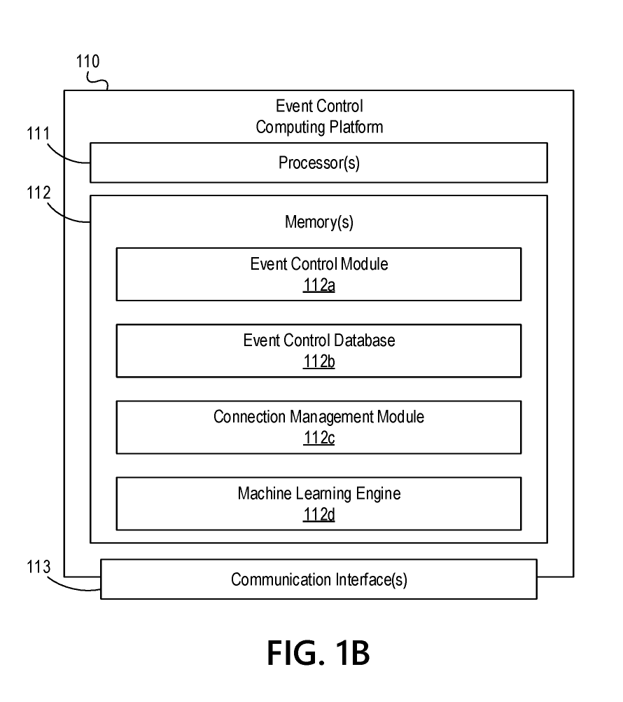

FIGS. 1A and 1B depict an illustrative computing environment for validating and controlling events executed across multiple computing platforms and devices in accordance with one or more example embodiments. Referring to FIG. 1A, computing environment 100 may include one or more computer systems, one or more computer networks, and/or other computing infrastructure. For example, computing environment 100 may include an event control computing platform 110, an event validation computing platform 120, an administrative computing device 130, a private network 140, a public network 150, a first social media service computing platform 160, a second social media service computing platform 170, a data feed aggregation server 180, a first supervisory user computing device 190, a second supervisory user computing device 191, a subordinate user computing device 195, and a subordinate user data source 196.

As discussed in greater detail below, event control computing platform 110 may include one or more computing devices configured to perform one or more of the functions described herein. For example, event control computing platform 110 may include one or more computers (e.g., laptop computers, desktop computers, servers, server blades, or the like) that are configured to orchestrate event validation operations and event control operations across multiple computer systems and devices in computing environment 100.

Event validation computing platform 120 may include one or more computing devices configured to validate events based on event data received from event control computing platform 110 and/or from other sources. For example, event validation computing platform 120 may receive, from event control computing platform 110 and/or one or more other systems, event information defining one or more events to be executed in computing environment 100, and event validation computing platform 120 subsequently may authorize and/or otherwise validate the one or more events to be executed in computing environment 100, so as to allow the events to proceed and/or otherwise be executed. In some instances, the one or more events may correspond to one or more financial transactions that have been requested by one or more computing devices, such as first supervisory user computing device 190, and/or subordinate user computing device 195, and event validation computing platform 120 may evaluate and/or selectively authorize the requested transactions based on information stored and/or maintained by event validation computing platform 120 (e.g., such as financial account information, account balance information, transaction history information, and/or account rules) and/or based on information received from event control computing platform 110 (e.g., such as user-specific transaction rules, account-specific transaction rules, user-specific trends information, user-segment trends information, and/or other information) and/or one or more other systems.

Administrative computing device 130 may be a desktop computer, laptop computer, workstation, or other computing device that is configured to be used by an administrative user, such as a network administrator associated with an organization operating event control computing platform 110 and/or event validation computing platform 120.

Social media service computing platform 160 may include one or more computing devices configured to host a first social media service (which may, e.g., be provided by an organization different from the organization operating event control computing platform 110 and/or event validation computing platform 120). In some instances, social media service computing platform 160 may maintain user profile information for various users of the first social media service, provide user interfaces associated with the first social media service to various user devices (e.g., first supervisory user computing device 190, second supervisory user computing device 191, subordinate user computing device 195), and provide activity feed data to other systems and/or devices included in computing environment 100, such as event control computing platform 110, event validation computing platform 120, data feed aggregation server 180, and/or the like. For instance, social media service computing platform 160 may, in some arrangements, provide activity feed data (e.g., such as user-specific image data, user-specific geolocation data, user-specific likes data, and/or other user-specific data) to event control computing platform 110 to enable one or more functions provided by event control computing platform 110 (e.g., such as social-media-enabled financial-transaction functions).

Social media service computing platform 170 may include one or more computing devices configured to host a second social media service (which may, e.g., be provided by an organization different from the organization operating event control computing platform 110 and/or event validation computing platform 120). Additionally, the second social media service may be different from the first social media service (e.g., the second social media service may be provided by an organization different from the organization providing the first social media service). In some instances, social media service computing platform 170 may maintain user profile information for various users of the second social media service, provide user interfaces associated with the second social media service to various user devices (e.g., first supervisory user computing device 190, second supervisory user computing device 191, subordinate user computing device 195), and provide activity feed data to other systems and/or devices included in computing environment 100, such as event control computing platform 110, event validation computing platform 120, data feed aggregation server 180, and/or the like. For instance, social media service computing platform 170 may, in some arrangements, provide activity feed data (e.g., such as user-specific image data, user-specific geolocation data, user-specific likes data, and/or other user-specific data) to event control computing platform 110 to enable one or more functions provided by event control computing platform 110 (e.g., such as social-media-enabled financial-transaction functions).

Data feed aggregation server 180 may include one or more computing devices configured to aggregate data feeds from various source systems (e.g., social media service computing platform 160, social media service computing platform 170, subordinate user data source 196, and/or other sources) and/or communicate data feeds to various destination systems (e.g., event control computing platform 110). In some instances, data feed aggregation server 180 may receive social media activity feed data from various social media platforms (e.g., social media service computing platform 160, social media service computing platform 170), merchant offer data from various merchant platforms (e.g., defining one or more merchant-specific offers that may be redeemable by customers at such merchants), activity data related to the activity of the subordinate user (e.g., subordinate user data source 196), and/or other activity data and/or content from other sources, and data feed aggregation server 180 may aggregate any and/or all of the received data to produce an aggregated data feed. Subsequently, data feed aggregation server 180 may communicate and/or otherwise provide the aggregated data feed to one or more destination systems, such as event control computing platform 110, so as to enable one or more functions provided by event control computing platform 110 (e.g., such as social-media-enabled financial-transaction functions). In some instances, the aggregated data feed may be communicated by data feed aggregation server 180 to event control computing platform 110 via a secure and/or encrypted communications link established between event control computing platform 110 and data feed aggregation server 180.

First supervisory user computing device 190 may be a desktop computer, laptop computer, workstation, or other computing device that is configured to be used by a supervisory user. Subordinate user computing device 195 may be a desktop computer, laptop computer, workstation, a wearable computer, or other computing device that is configured to be used by a subordinate user. For example, subordinate user computing device 195 may be a wearable computing device including one or more sensors such as a motion sensor, a location sensor (e.g., global positioning system (GPS)), a camera sensor, or other such sensors that may be used to track activity of users. In some arrangements, the supervisory user may be a parent and the subordinate user may be a teen or other minor supervised by the parent. For instance, the user of first supervisory user computing device 190 may utilize first supervisory user computing device 190 to define one or more rules (e.g., such as spending limits, transaction approval conditions, and/or the like) for the user of subordinate user computing device 195. In addition, as the user of subordinate user computing device 195 utilizes subordinate user computing device 195 and/or one or more other systems and/or devices to request transactions, event control computing platform 110 and/or event validation computing platform 120 may selectively authorize such transactions based on rules received from first supervisory user computing device 190 and/or defined by the user of first supervisory user computing device 190 and/or based on other factors and/or rules.

Second supervisory user computing device 191 may be a desktop computer, laptop computer, workstation, or other computing device that is configured to be used by a supervisory user. In some arrangements, the supervisory user may be a parent and the subordinate user may be a teen or other minor supervised by the parent. The second supervisory user computing device 191 may be configured to be used by a non-parental supervisory user. For instance, the second supervisory user computing device 191 may be configured to be used by a supervisory adult who is granted some supervisory functions over the subordinate user but not others. As an example, a the second supervisory user computing device 191 may be configured to be used by a non-custodial adult relative, an employer, a teacher, a coach, a neighbor, or other such non-parental supervisory user with some supervisory functions.

Computing environment 100 also may include one or more networks, which may interconnect one or more of event control computing platform 110, event validation computing platform 120, administrative computing device 130, social media service computing platform 160, social media service computing platform 170, data feed aggregation server 180, first supervisory user computing device 190, second supervisory user computing device 191, and subordinate user computing device 195. For example, computing environment 100 may include private network 140, which may be owned and/or operated by a specific organization and/or which may interconnect one or more systems and/or other devices associated with the specific organization. For example, event control computing platform 110, event validation computing platform 120, and administrative computing device 130 may be owned and/or operated by a specific organization, such as a financial institution, and private network 140 may interconnect event control computing platform 110, event validation computing platform 120, administrative computing device 130, and one or more other systems and/or devices associated with the organization. Additionally, private network 140 may connect (e.g., via one or more firewalls) to one or more external networks not associated with the organization, such as public network 150. Public network 150 may, for instance, include the internet and may connect various systems and/or devices not associated with the organization operating private network 140. For example, public network 150 may interconnect social media service computing platform 160, social media service computing platform 170, data feed aggregation server 180, first supervisory user computing device 190, second supervisory user computing device 191, subordinate user computing device 195, subordinate user data source 196, and/or various other systems and/or devices.

In some arrangements, the computing devices that make up and/or are included in event control computing platform 110, event validation computing platform 120, administrative computing device 130, social media service computing platform 160, social media service computing platform 170, data feed aggregation server 180, first supervisory user computing device 190, second supervisory user computing device 191, subordinate user computing device 195, and subordinate user data source 196 may be any type of computing device capable of receiving a user interface, receiving input via the user interface, and communicating the received input to one or more other computing devices. For example, the computing devices that make up and/or are included in event control computing platform 110, event validation computing platform 120, administrative computing device 130, social media service computing platform 160, social media service computing platform 170, data feed aggregation server 180, first supervisory user computing device 190, second supervisory user computing device 191, subordinate user computing device 195, and subordinate user data source 196 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of the computing devices that make up and/or are included in event control computing platform 110, event validation computing platform 120, administrative computing device 130, social media service computing platform 160, social media service computing platform 170, data feed aggregation server 180, first supervisory user computing device 190, second supervisory user computing device 191, subordinate user computing device 195, and subordinate user data source 196 may, in some instances, be special-purpose computing devices configured to perform specific functions.

Referring to FIG. 1B, event control computing platform 110 may include one or more processor(s) 111, memory(s) 112, and communication interface(s) 113. A data bus may interconnect processor(s) 111, memory(s) 112, and communication interface(s) 113.

Communication interface(s) 113 may be one or more network interfaces configured to support communications between event control computing platform 110 and one or more networks (e.g., private network 140, public network 150). For example, event control computing platform 110 may establish one or more connections and/or communication links to one or more other systems and/or devices (e.g., event validation computing platform 120, administrative computing device 130, social media service computing platform 160, social media service computing platform 170, data feed aggregation server 180, first supervisory user computing device 190, second supervisory user computing device 191, and subordinate user computing device 195) via communication interface(s) 113, and event control computing platform 110 may exchange data with the one or more other systems and/or devices (e.g., event validation computing platform 120, administrative computing device 130, social media service computing platform 160, social media service computing platform 170, data feed aggregation server 180, first supervisory user computing device 190, second supervisory user computing device 191, subordinate user computing device 195, and subordinate user data source 196) via communication interface(s) 113 while the one or more connections and/or communication links are established. Memory(s) 112 may include one or more program modules having instructions that when executed by processor(s) 111 cause event control computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of event control computing platform 110 and/or by different computing devices that may form and/or otherwise make up event control computing platform 110.

For example, memory(s) 112b may have, store, and/or include an event control module 112a, an event control database 112b, a connection management module 112c, and a machine learning engine 112d. Event control module 112a may have, store, and/or include instructions that direct and/or cause event control computing platform 110 to orchestrate event validation operations and event control operations across multiple computer systems and devices in computing environment 100 and perform other associated functions, as discussed in greater detail below. Event control database 112b may store information used by event control computing platform 110 in orchestrating event validation operations and event control operations across multiple computer systems and devices in computing environment 100 and in performing other associated functions. Connection management module 112c may have, store, and/or include instructions that direct and/or cause event control computing platform 110 to establish one or more connections and/or communication links to one or more other systems and/or devices (e.g., event validation computing platform 120, administrative computing device 130, social media service computing platform 160, social media service computing platform 170, data feed aggregation server 180, supervisory user computing device 190, and subordinate user computing device 195) via communication interface(s) 113 and/or to manage and/or otherwise control the exchanging of data with the one or more other systems and/or devices (e.g., event validation computing platform 120, administrative computing device 130, social media service computing platform 160, social media service computing platform 170, data feed aggregation server 180, first supervisory user computing device 190, second supervisory user computing device 191, subordinate user computing device 195, subordinate user data source 196) via communication interface(s) 113 while the one or more connections and/or communication links are established. Machine learning engine 112d may have, store, and/or include instructions that direct and/or cause event control computing platform 110 to dynamically analyze data collected by event control computing platform 110 based on historical data sets and/or present operations and automatically optimize the functions provided by event control computing platform 110 based on analyzing such data.

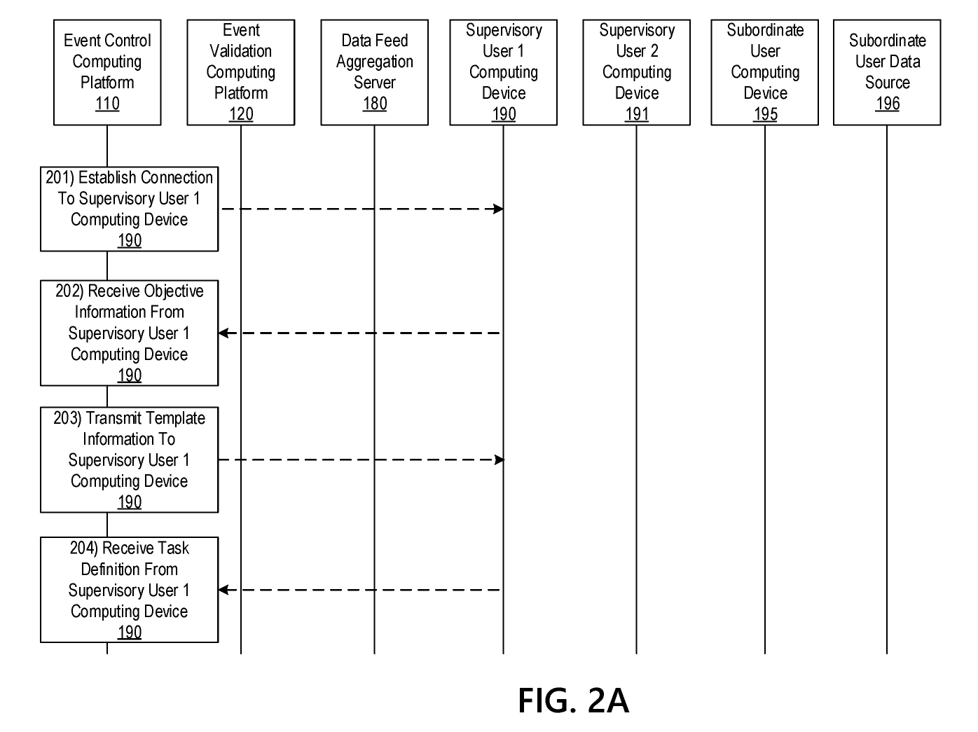

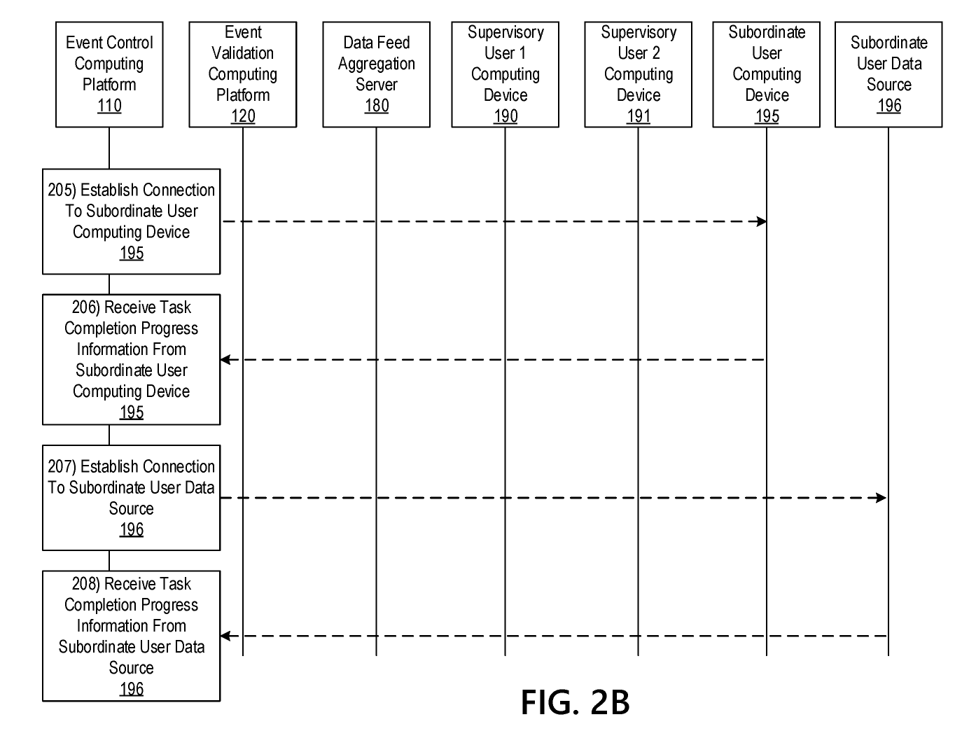

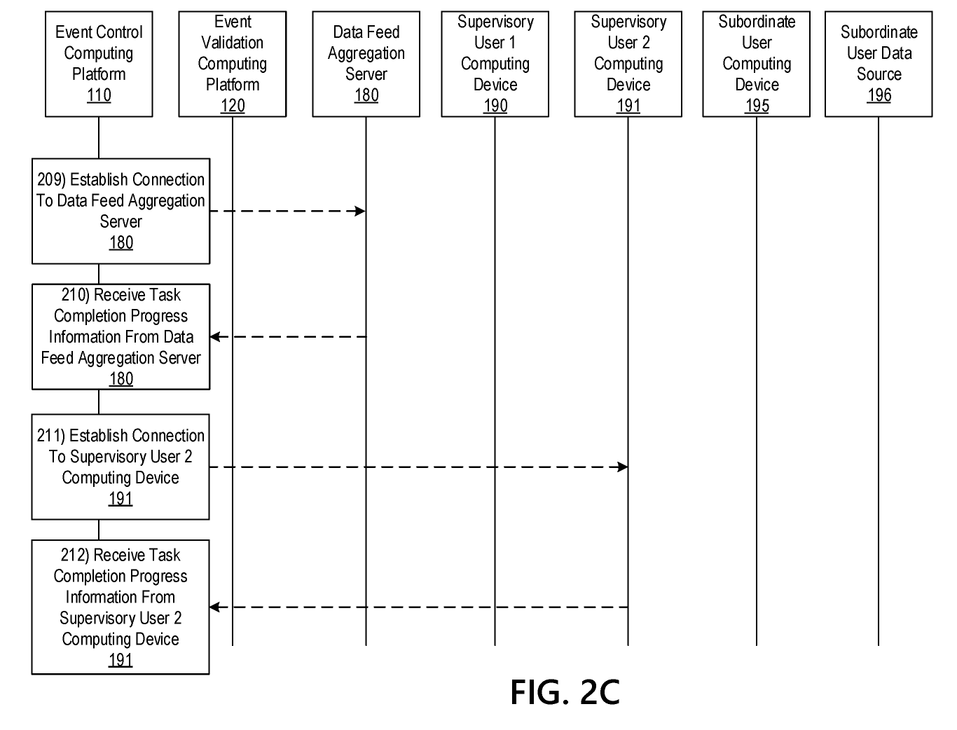

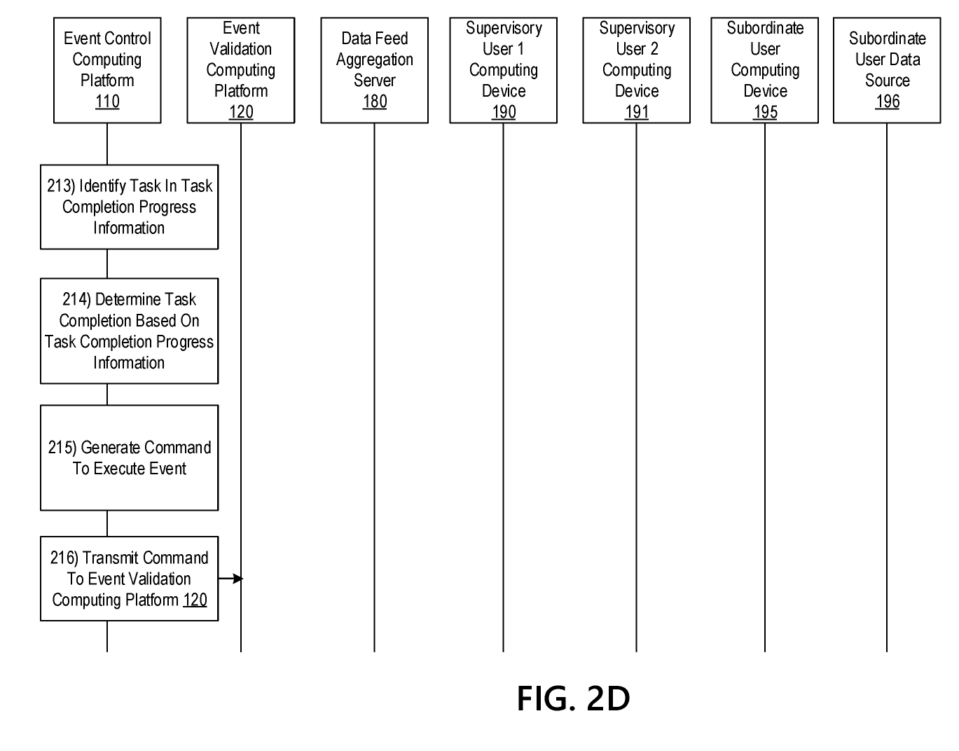

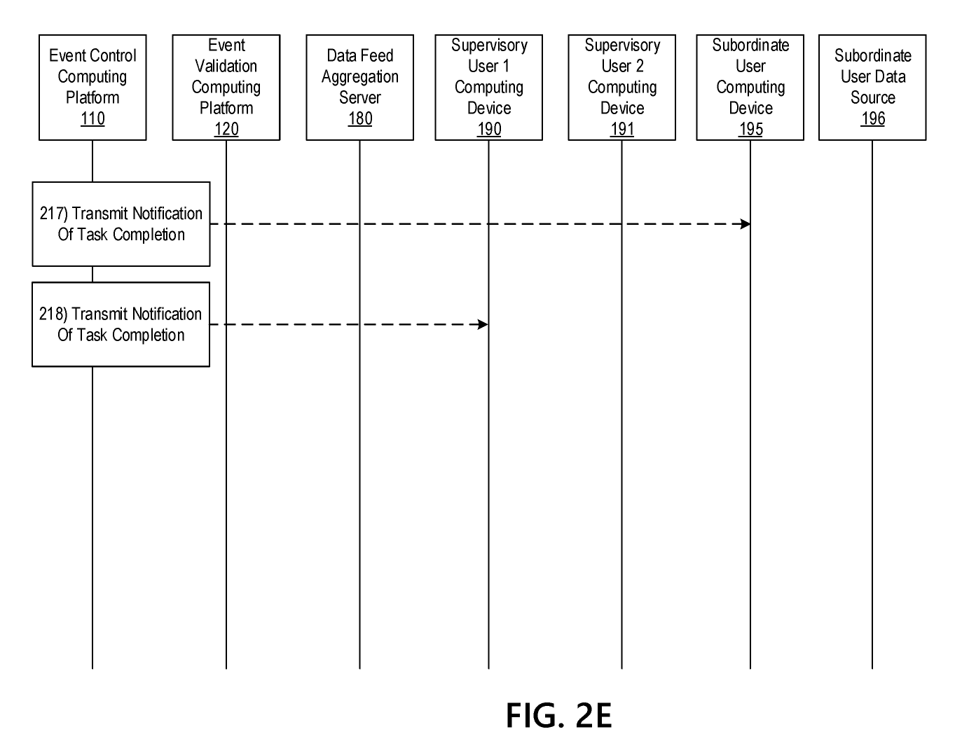

FIGS. 2A-2E depict an illustrative event sequence for multicomputer processing of user data with centralized event control in accordance with one or more example embodiments. Referring to FIG. 2A, at step 201, event control computing platform 110 may establish, via communication interface 113, a first connection to first supervisory user computing device 190. Once event control computing platform 110 has established a connection to first supervisory user computing device 190, event control computing platform 110 may receive information indicating an objective associated with a subordinate user from the first supervisory user computing device 190 at step 202.

For example, the objective associated with a subordinate user may be a financial objective associated with a subordinate user. An example of a financial objective may be to reach a designated financial account balance level, or to perform a particular financial transaction. As an example, the objective may be to save sufficient funds to make a certain purchase. The objective may be related to one or more activities. For example, the objective may be related to an activity that a subordinate user associated with a subordinate user computing device desires to do, such as a summer camp or a vacation. The financial objective may be to save sufficient funds to facilitate the activity. The objective may define, for example, a desired amount to be saved or acquired, and an objective date by which the objective is desired to be achieved. In some examples, no objective date is associated with the objective. Any of these and other such objective parameters may be received by event control computing platform 110 from the first supervisory user computing device 190 at step 202.

Referring back to FIG. 2A, at step 203, event control computing platform 110 may transmit a task template to first supervisory user computing device 190. The task template may be a suggestion of tasks that the event control computing platform 110 provides to first supervisory user computing device 190. In some examples, first supervisory user computing device 190 may adjust or edit the task template and/or individual tasks of the task template. A task template may include information defining a collection of tasks. A task may be any action for an operator of a subordinate user computing device 195 to do. For example a task may be for a subordinate user to mow a lawn, or other such task.

Tasks may be associated with a corresponding event for event validation computing platform 120 to execute to change user data associated with the operator of a subordinate user computing device 195. For example, a task may be associated with event information defining one or more events to be executed in computing environment 100, and event validation computing platform 120 subsequently may authorize and/or otherwise validate the event to be executed in computing environment 100, so as to allow the event to proceed and/or otherwise be executed. In some instances, the event may correspond to one or more financial transactions that are related to a financial objective. For example, if the objective is to achieve a target funding level in a financial account, the task may be associated with an event to transfer funds from a source to that financial account. The event may be executed by event validation computing platform 120, so as to allow the event to proceed and/or otherwise be executed.

The plurality of tasks may be ordered, such that a first task must be completed before a second task can be completed. One example of a task may be to mow a lawn. Another example of a task may be to pick up leaves on the lawn. These two tasks may be specified in information included in a task template used by event control computing platform 110, and ordered such that a subordinate user must pick up the leaves before mowing the lawn in order to complete the tasks. Further examples of tasks are provided in the following discussion.

In some examples, step 203 may be omitted and the plurality of tasks may be input by a supervisory user at supervisory user computing device 190, or determined autonomously by event control computing platform 110. In any case, event control computing platform 110 may receive information defining a plurality of tasks associated with the objective from the first supervisory user computing device 190 at step 204.

Next, event control computing platform 110 may receive, via the communication interface, task completion progress information. Task completion progress information may be any information that can be analyzed by event control computing platform 110 to determine if a task has been completed. If the task has been completed, the event control computing platform 110 may transmit a command to event validation computing platform 120 to execute a related event. Event control computing platform 110 may establish connections with and receive task completion progress information from a number of sources. For example, at step 205 in FIG. 2B, event control computing platform 110 may establish, via communication interface 113, a first connection to subordinate user computing device 195. Once event control computing platform 110 has established a connection to subordinate user computing device 195, event control computing platform 110 may receive task completion progress information from subordinate user computing device 195 at step 206.

In an example, subordinate user computing device 195 may be a handheld computing device such as a smartphone. The subordinate user computing device 195 may include a location sensor such as a global positioning system (GPS) sensor or other such location sensors capable of providing location information. In an example, the task completion progress information may include location information that confirms the location or activity of the subordinate user computing device 195. An example task that may be associated with location information may be, for example, a task to not exit a predefined area (e.g., a geofence), or to be at a particular location at a particular time (e.g., to ensure a student is at school during school hours).

Subordinate user computing device 195 may include an image sensor, and task completion progress information may include an image acquired by the image sensor. For example, a subordinate user may be tasked with mowing a lawn, and may take a photo with the image sensor of subordinate user computing device 195 of the mowed grass to indicate that the task was completed. In some aspects, image recognition software operating either on subordinate user computing device 195 or event control computing platform 110 may perform automatic recognition of various objects or conditions indicated in the image. In some aspects, the image may be presented by a supervisory user computing device to a supervisory user for confirmation that the image reflects completion of a task. For example, to determine that the task is complete, event control computing platform 110 may transmit an image to supervisory user computing device 190 and cause supervisory user computing device 190 to display the image to a supervisory user operating supervisory user computing device 190. Supervisory user computing device 190 may request input indicating whether or not the image indicates that the task is complete from the supervisory user. The answer as to whether or not the image indicates that the task is complete may be transmitted to event control computing platform 110 and used to determine that the task completion progress information indicates completion of the first task.

In an example, subordinate user computing device 195 may be a wearable computing device such as a digital pedometer or other such activity tracking wearable device. In this example, the task completion progress information may include information derived from various sensor readings of the wearable device. For example, the task completion progress information may include an indication of a number of steps taken by the subordinate user as determined by the wearable device and its sensors.

In a further example, subordinate user computing device 195 may otherwise use data available from other sensors or combination of sensors to determine some activity of a subordinate user. For example, subordinate user computing device 195 may be integral to or otherwise interface with a vehicle computing platform. In this example, the vehicle computing platform may be configured to detect, among other conditions, a speeding condition, a geofence boundary condition, an accident or emergency condition, or other such condition of a vehicle reflective of a subordinate user's operation of the vehicle. In such examples, a corresponding task may reflect an objective to not speed while driving for a certain period of time. If no speeding is detected by the vehicle computing platform within the period of time, the task may be completed. If any speeding is detected by the vehicle computing platform within the period of time, the task may incomplete.

In an example, subordinate user computing device 195 may record and report usage metrics of the subordinate user computing device 195 and include such metrics or derived data in task completion progress information. For example, subordinate user computing device 195 may record the amount of time the subordinate user operates the subordinate user computing device 195. In an example, the subordinate user computing device 195 may be a gaming computing device, and the relevant metric may be total time the gaming computing device is operational during a period of time. If the total time the gaming computing device is operational during a period of time is below a threshold, an associated task may be completed. If the total time the gaming computing device is operational during a period of time is above the threshold, the associated task may be not completed. In an example, subordinate user adherence to a usage schedule or curfew may be one metric derived from operational information of subordinate user computing device 195 and included in task completion progress information.

Task completion information may be received from an external data source. At step 207, event control computing platform 110 may establish, via communication interface 113, a first connection to subordinate user data source 196. Once event control computing platform 110 has established a connection to subordinate user data source 196, event control computing platform 110 may receive task completion progress information from subordinate user data source 196 at step 208. Subordinate user data source 196 may be any computing platform or device that supplies information about the subordinate user's actions or activity related to the completion of tasks. For example, subordinate user data source 196 may be a school grade-keeping system that makes available the grades earned in school by a subordinate user associated with subordinate user computing device 195. In this example, a corresponding task may be related to achieving a certain grade in a certain class, or achieving a defined overall grade-point average. To verify if the task is complete, then, event control computing platform 110 may establish a connection to the subordinate user data source 196 (i.e., a school grade-keeping system) and receive task completion progress information. The task completion progress information may comprise confirmation that the grading metric set forth in the associated task has been met. The task completion progress information may comprise grading data which the event control computing platform 110 may analyze and compare to the task definition to determine if the task is completed.

In another example, subordinate user data source 196 may be a time and attendance system that tracks the subordinate user's attendance at an institution. For example, like the grade-keeping system discussed above, the time and attendance system may record and track the subordinate user's attendance at a school or other educational institution. Still other examples of a time and attendance system may track, for example, participation in an extracurricular activity, time spent volunteering, time spent practicing a sport or musical instrument, or other such activities that may be encouraged by a supervisory user.

Event control computing platform 110 may establish connections with and receive task completion progress information from a plurality of social media platforms. For example, event control computing platform 110 may establish, via communication interface 113, a first connection to a first social media service computing platform 160 and in step 204, event control computing platform 110 may establish, via communication interface 113, a second connection to a second social media service computing platform 170. In some instances, event control computing platform 110 may establish connections to any number of social media service computing platforms. In some aspects, a data feed aggregation server 180 may aggregate all of the information from social media service computing platforms 160, 170 and other sources prior to processing that information.

At step 209 in FIG. 2C, event control computing platform 110 may establish, via communication interface 113, a first connection to data feed aggregation server 180. Once event control computing platform 110 has established a connection to data feed aggregation server 180, event control computing platform 110 may receive task completion progress information from data feed aggregation server 180 at step 210. Through data feed aggregation server 180, event control computing platform 110 may access information from social media service computing platforms 160, 170 and other sources.

Social media service computing platforms 160, 170 may provide one or more social media feeds with information related to one or more users. A user may register with social media service computing platforms 160, 170 and social media service computing platforms 160, 170 may generate a user account and associated user credentials for logging into the user account. When the user enters valid user credentials, social media service computing platforms 160, 170 may provide the user with access to one or more services hosted by social media service computing platforms 160, 170. For example, the services hosted by social media service computing platforms 160, 170 may enable the user to receive and transmit messages to other users, upload pictures, share content of interest, and provide location information to generate a personalized social media feed associated with the user. The services hosted by social media service computing platforms 160, 170 also may enable the user to control who has access to the information in his or her personalized social media feed. For example, the user may limit access to user devices associated with friends, close acquaintances, or family members. In some examples, the user may also allow access to user devices associated with users that do not have an account on social media service computing platforms 160, 170.

Event control computing platform 110 (and/or associated devices such as administrative computing device 130) may also have access to a given user's social media feed on social media service computing platforms 160, 170 through private network 140 and public network 150. This access may be provided by the user associated with a given user account or someone who supervises the user associated with the user account (e.g., parent, guardian, or the like). Thus, once event control computing platform 110 has established connections to social media service computing platforms 160, 170 via data feed aggregation server 180, event control computing platform 110 may receive aggregated social media information from data feed aggregation server 180 including social media information from the first social media service computing platform 160 and from the second social media service computing platform 170. In addition, event control computing platform 110 may also establish connections to supervisory and subordinate user computing devices 190, 195 and receive additional information from these devices. Further still, event control computing platform 110 may receive additional information (e.g., information about financial transactions made by a given user, or the like) from additional sources (e.g., financial accounts) accessible to platform 110. Event control computing platform 110 may be specially configured to include decryption capabilities to allow the information to be transmitted safely and securely.

In some aspects, event control computing platform 110 may receive information from data feed aggregation server 180 in real time as data is posted to social media service computing platforms 160, 170. In one example, in receiving information in real time, the information may be received by event control computing platform 110 within two minutes of being posted to social media service computing platforms 160, 170.

In some examples, task completion progress information received from data feed aggregation server 180 may relate to tasks related to social media service computing platforms 160, 170. For example, one such task may be to do or to not do certain actions related to social media service computing platforms 160, 170. In an example, such a task may be defined to not engage in certain behaviors on social media service computing platforms 160, 170. If the relevant subordinate user adheres to the parameters of the task by doing or not doing the certain behavior for a period of time, the task may be completed. For example, a task may be completed if a user operating subordinate user computing device 190 performs a check-in at a certain location using one of social media service computing platforms 160, 170. In an example, an aspect of a user's posting history may be related to a task definition. For example, a task may be to limit social media posts to a predefined number in a given period of time, or to abstain from posting during a period of time. One task may be to, for example, abstain from using one of social media service computing platforms 160, 170 during school hours. In these examples and others, event control computing platform 110 may receive social media information a plurality of social media service computing platforms which may include task completion progress information relevant to determining the completion of one or more tasks.

Event control computing platform 110 may receive task completion information from a second supervisory user computing device 191. The second supervisory user computing device 191 may be configured to be used by a non-parental supervisory user. For instance, the second supervisory user computing device 191 may be configured to be used by a supervisory adult who is granted some supervisory functions over the subordinate user but not others. As an example, a the second supervisory user computing device 191 may be configured to be used by a non-custodial adult relative, an employer, a teacher, a coach, a neighbor, or other such non-parental supervisory user with some supervisory functions. At step 211, event control computing platform 110 may establish, via communication interface 113, a first connection to second supervisory user computing device 191. Once event control computing platform 110 has established a connection to second supervisory user computing device 191, event control computing platform 110 may receive task completion progress information from second supervisory user computing device 191 at step 212.

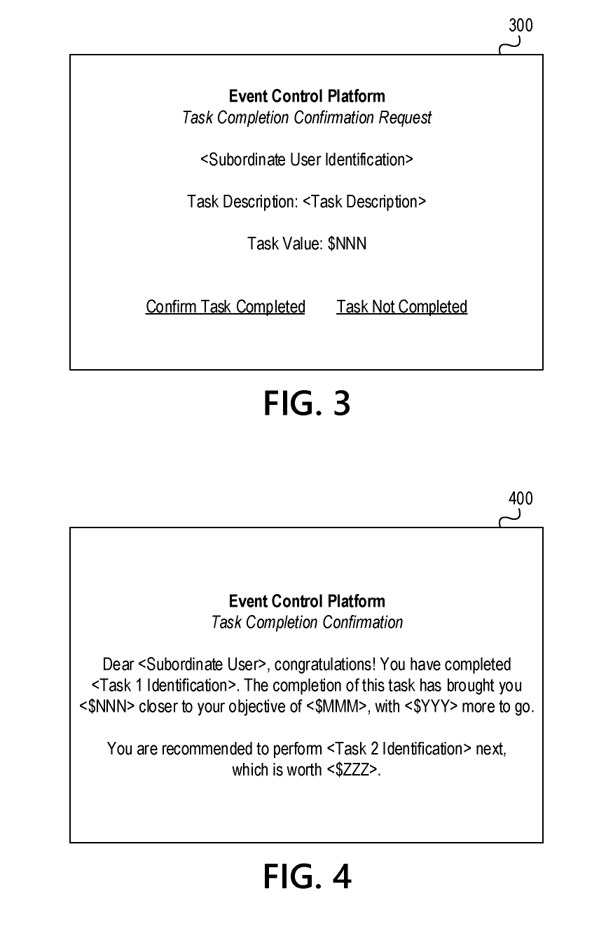

To obtain task completion confirmation from a second supervisory user computing device 191, event control computing platform 110 may cause second supervisory user computing device 191 to display and/or otherwise present a graphical user interface similar to graphical user interface 300, which is illustrated in FIG. 3. As shown in FIG. 3, graphical user interface 300 may present information related to the task and receive input either confirming or denying completion of the task. For example, interface 300 may include an identification of the relevant subordinate user, a description of the task that the subordinate user has completed, and the value associated with the task. In some examples, the second supervisory user may contribute the funds to fund the task value. Rather than the first supervisory user (e.g., a parent) funding the task, the second supervisory user (e.g., an uncle) may directly contribute funds through graphical user interface 300 to fund the completion of the task. In these examples, if a second supervisory user contributes funds to fund the completion of the task, the event associated with the task may be modified accordingly to withdraw funds from an account associated with the second supervisory user and deposit funds in an account associated with the objective. In some examples, the event may be unmodified.

In some examples, the second supervisory user may use second supervisory user computing device 191 to send a text message, email, voicemail, or any other type of message to event control computing platform 110 to indicate whether she confirms the subordinate user has completed the task. If the second supervisory user indicates that the task was not completed by the subordinate user, the process may stop at step 212.

Turning to FIG. 2D, at step 213, event control computing platform 110 may next identify a task from the task completion progress information received in any of steps 205-212. Depending on the source and type of the task completion progress information, the task completion progress information may be parsed or otherwise processed by event control computing platform 110 to determine the task that the task completion progress information is associated with. In some examples, the task completion information may contain information relevant to more than one task. Next, the task completion progress information may be evaluated by event control computing platform 110 to determine if the task completion progress information indicates that the identified task is complete. In some examples, the task completion progress information may include an explicit directive that the identified task is either complete or not complete. In some examples, the task completion progress information may be analyzed by event control computing platform 110 to determine if the task is complete or not complete. For example, event control computing platform 110 may apply rules, conditions, heuristics, or other such items to the task completion progress information by event control computing platform 110 to determine if the task is complete. If the task completion progress information indicates that the task is not complete, the process may end at this point.

At step 214, the event control computing platform 110 may determine that the task is completed based on the received task completion progress information. The determination may be based on, among other factors, a comparison of the information defining the task with the task completion progress information. Examples of tasks and associated task completion progress information are provided in connection with steps 205-212. Next, in step 215, event control computing platform 110 may generate a command directing event validation computing platform 120 to execute an event associated with the task. For example, the event may instruct one or more computing systems to change user data associated with the relevant subordinate user. In one example, the command generated by event control computing platform 110 may direct the event validation computing platform 120 to execute one or more actions to cause a change to user data associated with the first subordinate user. The one or more actions may cause event validation computing platform 120 to, for example, transfer funds from a first account to a second account associated with the subordinate user so that the subordinate user has access to the funds. In an example, the event validation computing platform 120 may authorize the usage of funds in an account associated with the subordinate user so that the subordinate user may access the funds. In these examples and others, the event executed by event validation computing platform 120 may contribute to achieving the objective received in step 202 from first supervisory user computing device 190.

Once a command has been generated, event control computing platform 110 may then transmit, to event validation computing platform 120, the command directing event validation computing platform 120 to change the user data associated with the relevant subordinate user in step 216. Event validation computing platform 120 may then execute the command and perform any actions to change user data according to the command received from event control computing platform 110. Finally, in steps 217 and 218 in FIG. 2E, event control computing platform 110 may then transmit a notification of the completion of the identified task to either subordinate user computing device 195 (e.g., at step 217) and/or the first supervisory user computing device 190 (e.g., at step 218). In response, the receiving user device may display the received notification. For example, event control computing platform 110 may transmit a notification to subordinate user computing device 195 which causes subordinate user computing device 195 to display the notification. Similarly, event control computing platform 110 may transmit a notification to supervisory user computing device 190 which causes supervisory user computing device 190 to display the notification.

Event control computing platform 110 may transmit a notification to subordinate user computing device 195 which causes subordinate user computing device 195 to display and/or otherwise present a graphical user interface similar to graphical user interface 400, which is illustrated in FIG. 4. Graphical user interface 400 may display, for example, an identification of the task that was completed, the value associated with the completed task, and information related to the subordinate user's progress toward completing their objective. Graphical user interface 400 may also display a recommendation for a next task to perform, and the value associated with the recommended task. The recommended task may be recommended based on, for example, a task template. In an example, the information presented in graphical user interface 400 may be presented to the subordinate user in an augmented reality (AR) display.

In some aspects, event control computing platform 110 may reprogram functionality of platform 110, using machine learning engine 112d, to determine a task template corresponding to an objective of a subordinate user, and further to alter a task template. A task template may be a suggestion of a collection of tasks that the event control computing platform 110 provides to first supervisory user computing device 190 at, for example, step 203 as previously discussed. Event control computing platform 110 may alter or adjust a task template based on a number of factors. For example, platform 110 may alter a task of the task template based on past task performance of a subordinate user, financial transaction history of a supervisory user, crowd-sourced task performance data, or social media information of a number of other individuals about which event control computing platform 110 receives information, or other similar information. In an example, event control computing platform 110 may identify a particular task or characteristic of tasks that a given subordinate user is likely to successfully perform. Similarly, event control computing platform 110 may identify other particular tasks or characteristics of tasks that a given subordinate user is unlikely to successfully perform.

For example, event control computing platform 110 may assign each characteristic of a task to one of a plurality of learning dimensions. As an example, a characteristic of a task may be the value associated with the task, and the associated learning dimension may be related to the value of tasks. Other such learning dimensions may include, for example, the type of task completion progress information associated with the task (e.g., location information, activity information, grade information, or any other example discussed herein), the quantity of task completion progress information or duration associated with the task (e.g., a one-time location check-in compare to a week-long adherence to a device usage schedule), the identity of the supervisory user who selected the task, the time that has elapsed since the task was selected, the objective associated with the task, whether the task was completed or not, or other such task information. Then, a history of a particular subordinate user's task completion may be mapped to the plurality of learning dimensions to generate a learning dataset. A machine learning algorithm executed by machine learning engine 112d may then be used to analyze the learning dataset to generate a predictive model. For example, machine learning engine 112d may employ any of or a combination of a Bayesian classifier, a support vector machine, a neural network, a principal component analysis, or any other such analysis to generate a predictive model. Then, once a predictive model has been generated by such analysis, a new task may be analyzed using the same technique and same dimensions to determine a likelihood that the task will be completed by the same subordinate user. Such task performance history analysis may also be crowd-sourced by event control computing platform 110 from other subordinate user behavior and influence the task template determined by event control computing platform 110 for a particular subordinate user.

In some examples, event control computing platform 110 may reprogram functionality of platform 110, using machine learning engine 112d, to determine a value to associate with a task. Machine learning engine 112d may employ similar techniques as described above to determine the degree to which value contributes to an overall likelihood that a given task may be completed. For example, the learning dimension of task value may be isolated and characterized independently of other learning dimensions of the task. The characterization may be a probability density function or a cumulative distribution function. The characterization of the influence of a task value on a given task may then be analyzed with respect to predetermined probability thresholds or densities to determine actionable suggestions for users. For example, a threshold for a high likelihood may be set at a 75% probability, and a threshold for a low likelihood may be set at a 25% probability. In an example, the event control computing platform 110 may determine that a value of $5 for a task results in a low likelihood of subordinate users performing the task. However, the event control computing platform 110 may determine that a value of $15 for the same task results in a high likelihood of subordinate users performing the task. Based on the same analysis, the event control computing platform 110 may determine that a value of $20 or higher for the task does not significantly increase the likelihood of subordinate users performing the task. In this way, the event control computing platform 110 may assist a supervisory user in determining an optimal task value for a task.

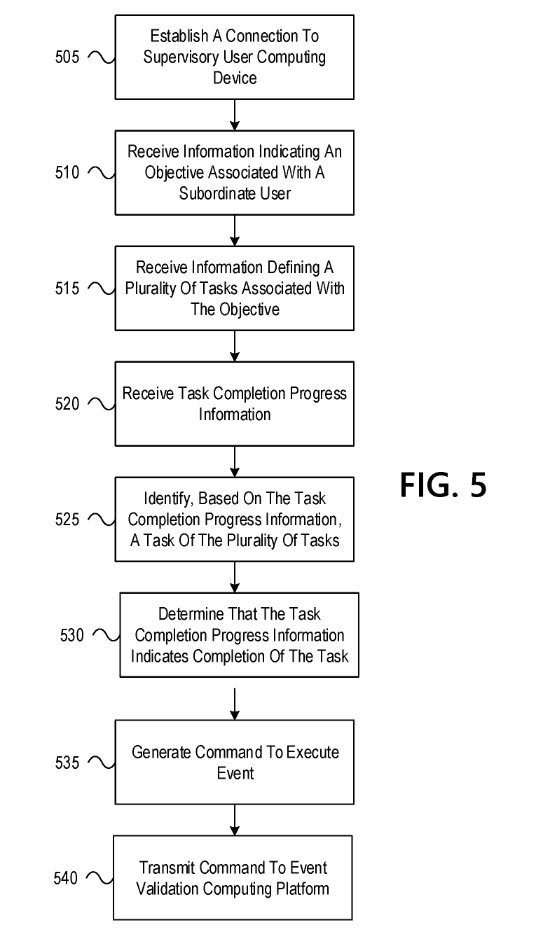

FIG. 5 depicts an illustrative method for multicomputer processing of user data with centralized event control in accordance with one or more example embodiments. Referring to FIG. 5, at step 505, a computing platform having at least one processor, a memory, and a communication interface may establish, via the communication interface, a first connection to first supervisory user computing device. Next, at step 510, the computing platform may, while the first connection is established, receive, via the communication interface, from the first supervisory user computing device, information indicating an objective associated with a subordinate user. Subsequently, at step 515, the computing platform may, while the first connection is established, receive, via the communication interface, from the first supervisory user computing device, information defining a plurality of tasks associated with the objective, wherein each task is associated with an event to cause a change to user data associated with the subordinate user. Next, the computing platform may receive, via the communication interface, task completion progress information at step 520. The task completion progress information received in at step 520 may be received from a variety of sources. Once the task completion progress information is received, the computing platform may identify, based on the task completion progress information, a first task of the plurality of tasks indicated by the task completion progress information at step 525. At step 530, the computing platform may determine, based on a comparison of the information defining the first task with the task completion progress information, that the task completion progress information indicates completion of the first task. In response to determining that the task completion progress information indicates completion of the first task, the computing platform may, at step 535, generate a command directing an event validation computing platform to execute an event associated with the task. Finally, in step 535, transmit, via the communication interface, to the event validation computing platform, the command directing the event validation computing platform to execute the event, wherein transmitting the command directing the event validation computing platform to execute the event causes the event validation computing platform to execute one or more actions to cause a change to user data associated with the subordinate user.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform, comprising:
at least one processor;
a communication interface communicatively coupled to the at least one processor; and
memory storing computer-readable instructions that, when executed by the at least one processor, cause the computing platform to:
establish, via the communication interface, a first connection to a first supervisory user computing device;
while the first connection is established, receive, via the communication interface, from the first supervisory user computing device, information indicating an objective associated with a subordinate user;
while the first connection is established, receive, via the communication interface, from the first supervisory user computing device, information defining a plurality of tasks associated with the objective, wherein each task is associated with an event to cause a change to user data associated with the subordinate user;
receive, via the communication interface, task completion progress information;
identify, based on the task completion progress information, a first task of the plurality of tasks indicated by the task completion progress information;
determine, based on a comparison of the information defining the first task with the task completion progress information, that the task completion progress information indicates completion of the first task;
in response to determining that the task completion progress information indicates completion of the first task, generate a command directing an event validation computing platform to execute an event associated with the task; and
transmit, via the communication interface, to the event validation computing platform, the command directing the event validation computing platform to execute the event, wherein transmitting the command directing the event validation computing platform to execute the event causes the event validation computing platform to execute one or more actions to cause a change to user data associated with the subordinate user.

2. The computing platform of claim 1, wherein the memory stores additional computer-readable instructions that, when executed by the at least one processor, cause the computing platform to:
establish, via the communication interface, a second connection to a subordinate user computing device associated with the subordinate user,
wherein the subordinate user computing device associated with the subordinate user comprises one or more sensors,
wherein the task completion progress information is received, while the second connection is established, from the subordinate user computing device,
wherein the task completion progress information comprises information derived from at least one of the one or more sensors of the subordinate user computing device associated with the subordinate user, and
wherein determining that the task completion progress information indicates completion of the first task comprises comparing the information derived from at least one of the one or more sensors of the subordinate user computing device associated with the subordinate user of the task completion progress information with a corresponding piece of information defining the first task.

3. The computing platform of claim 2, wherein the subordinate user computing device is a wearable computing device, the one or more sensors includes a location sensor, the task completion progress information includes location information derived from the location sensor of the wearable computing device, the information defining the first task comprises location information, and the corresponding piece of information defining the first task is the location information.

4. The computing platform of claim 1, wherein the memory stores additional computer-readable instructions that, when executed by the at least one processor, cause the computing platform to:
establish, via the communication interface, a second connection to a subordinate user data source associated with the subordinate user,
wherein the task completion progress information is received, while the second connection is established, from the subordinate user data source.

5. The computing platform of claim 1, wherein the memory stores additional computer-readable instructions that, when executed by the at least one processor, cause the computing platform to:
establish, via the communication interface, a second plurality of connections to a plurality of social media service computing platforms,
wherein the task completion progress information is received, while the second plurality of connections is established, from at least one of the plurality of social media service computing platforms,
wherein the task completion progress information comprises social media activity feed data, and
wherein determining that the task completion progress information indicates completion of the first task comprises comparing social media activity feed data with a corresponding piece of information defining the first task.

6. The computing platform of claim 1, wherein the memory stores additional computer-readable instructions that, when executed by the at least one processor, cause the computing platform to:
establish, via the communication interface, a second connection to a second supervisory user computing device,
wherein the task completion progress information is received, while the second connection is established, from the second supervisory user computing device,
wherein the task completion progress information comprises a command from the second supervisory user computing device directing the computing platform that the first task is complete.

7. The computing platform of claim 1, wherein the memory stores additional computer-readable instructions that, when executed by the at least one processor, cause the computing platform to:
transmit, via the communication interface, to the subordinate user computing device, a notification of the completion of the task, wherein transmitting the notification to subordinate user computing device causes the subordinate user computing device to display the notification of the completion of the task.

8. The computing platform of claim 1, wherein the memory stores additional computer-readable instructions that, when executed by the at least one processor, cause the computing platform to:
transmit, via the communication interface, to the first supervisory user computing device, a notification of the completion of the task, wherein transmitting the notification to the first supervisory user computing device causes the first supervisory user computing device to display the notification of the completion of the task.

9. The computing platform of claim 1, wherein the memory stores additional computer-readable instructions that, when executed by the at least one processor, cause the computing platform to:
in response to receiving information indicating an objective associated with a subordinate user, determine a task template corresponding to the objective; and
while the first connection is established and prior to receiving information defining a plurality of tasks associated with the objective, transmit to the first supervisory user computing device, via the communication interface, information indicating the task template.

10. The computing platform of claim 9, wherein the memory stores additional computer-readable instructions that, when executed by the at least one processor, cause the computing platform to:
reprogram functionality of the computing platform, using a machine learning engine, to alter the task template prior to transmitting information indicating the task template to the first supervisory user computing device.

11. A method, comprising:
at a computing platform comprising at least one processor, memory, and a communication interface:
establishing, via the communication interface, a first connection to a first supervisory user computing device;
while the first connection is established, receiving, via the communication interface, from the first supervisory user computing device, information indicating an objective associated with a subordinate user;
while the first connection is established, receiving, via the communication interface, from the first supervisory user computing device, information defining a plurality of tasks associated with the objective, wherein each task is associated with an event to cause a change to user data associated with the subordinate user;
receiving, via the communication interface, task completion progress information;
identifying, based on the task completion progress information, a first task of the plurality of tasks indicated by the task completion progress information;
determining, based on a comparison of the information defining the first task with the task completion progress information, that the task completion progress information indicates completion of the first task;
in response to determining that the task completion progress information indicates completion of the first task, generating a command directing an event validation computing platform to execute an event associated with the task; and
transmitting, via the communication interface, to the event validation computing platform, the command directing the event validation computing platform to execute the event, wherein transmitting the command directing the event validation computing platform to execute the event causes the event validation computing platform to execute one or more actions to cause a change to user data associated with the subordinate user.

12. The method of claim 11, further comprising:
establishing, via the communication interface, a second connection to a subordinate user computing device associated with the subordinate user,
wherein the subordinate user computing device associated with the subordinate user comprises one or more sensors,
wherein the task completion progress information is received, while the second connection is established, from the subordinate user computing device,
wherein the task completion progress information comprises information derived from at least one of the one or more sensors of the subordinate user computing device associated with the subordinate user, and
wherein determining that the task completion progress information indicates completion of the first task comprises comparing the information derived from at least one of the one or more sensors of the subordinate user computing device associated with the subordinate user of the task completion progress information with a corresponding piece of information defining the first task.

13. The method of claim 12, wherein the subordinate user computing device is a wearable computing device, the one or more sensors includes a location sensor, the task completion progress information includes location information derived from the location sensor of the wearable computing device, the information defining the first task comprises location information, and the corresponding piece of information defining the first task is the location information.

14. The method of claim 11, further comprising:
establishing, via the communication interface, a second plurality of connections to a plurality of social media service computing platforms,
wherein the task completion progress information is received, while the second plurality of connections is established, from at least one of the plurality of social media service computing platforms,
wherein the task completion progress information comprises social media activity feed data, and
wherein determining that the task completion progress information indicates completion of the first task comprises comparing social media activity feed data with a corresponding piece of information defining the first task.

15. The method of claim 11, further comprising:
establishing, via the communication interface, a second connection to a second supervisory user computing device,
wherein the task completion progress information is received, while the second connection is established, from the second supervisory user computing device,
wherein the task completion progress information comprises a command from the second supervisory user computing device directing the computing platform that the first task is complete.

16. The method of claim 11, further comprising: transmitting, via the communication interface, to the subordinate user computing device, a notification of the completion of the task, wherein transmitting the notification to subordinate user computing device causes the subordinate user computing device to display the notification of the completion of the task.

17. The method of claim 11, further comprising: transmitting, via the communication interface, to the first supervisory user computing device, a notification of the completion of the task, wherein transmitting the notification to the first supervisory user computing device causes the first supervisory user computing device to display the notification of the completion of the task.

18. The method of claim 11, further comprising:
in response to receiving information indicating an objective associated with a subordinate user, determining a task template corresponding to the objective; and
while the first connection is established and prior to receiving information defining a plurality of tasks associated with the objective, transmitting to the first supervisory user computing device, via the communication interface, information indicating the task template.

19. The method of claim 18, further comprising:
reprogramming functionality of the computing platform, using a machine learning engine, to alter the task template prior to transmitting information indicating the task template to the first supervisory user computing device.

20. One or more non-transitory computer-readable media storing instructions that, when executed by a computing platform comprising at least one processor, memory, and a communication interface, cause the computing platform to:
establish, via the communication interface, a first connection to a first supervisory user computing device;
while the first connection is established, receive, via the communication interface, from the first supervisory user computing device, information indicating an objective associated with a subordinate user;
while the first connection is established, receive, via the communication interface, from the first supervisory user computing device, information defining a plurality of tasks associated with the objective, wherein each task is associated with an event to cause a change to user data associated with the subordinate user;
receive, via the communication interface, task completion progress information;
identify, based on the task completion progress information, a first task of the plurality of tasks indicated by the task completion progress information;
determine, based on a comparison of the information defining the first task with the task completion progress information, that the task completion progress information indicates completion of the first task;
in response to determining that the task completion progress information indicates completion of the first task, generate a command directing an event validation computing platform to execute an event associated with the task; and
transmit, via the communication interface, to the event validation computing platform, the command directing the event validation computing platform to execute the event, wherein transmitting the command directing the event validation computing platform to execute the event causes the event validation computing platform to execute one or more actions to cause a change to user data associated with the subordinate user.
